(19) United States
(12) Patent Application Publication
(10) Pub. No.: US 2024/0296759 A1
(43) Pub. Date: Sep. 5, 2024

(54) DEVICE FOR EXPOSING DOCUMENTS

(71) Applicant: Daniela SARLI, Roma (RM) (IT)

(72) Inventor: Daniela SARLI, Roma (RM) (IT)

(21) Appl. No.: 18/550,561

(22) PCT Filed: Mar. 14, 2022
(86) PCT No.: PCT/IB2022/052263

§ 371 Date: Sep. 14, 2023

(30) Foreign Application Priority Data
Mar. 15, 2021 (IT) 102021000006062

(51) Int. Cl. G09F 7/20; G09F 7/18

(52) U.S. Cl. CPC G09F 7/20; G09F 2007/186

(57) ABSTRACT

A support device for exposing an information physical carrier is provided. The device includes a main body, having at its own exposing surface, a track, and a cursor, configured to engage with the track, and means for coupling to the information physical carrier. The overall configuration of the support device is such that the arrangement of the information physical carrier coupled to the cursor can be varied by sliding the cursor with respect to the track.

### FIELD OF THE INVENTION

The present invention relates to a device for exposing in an organized way one or more paper documents, such as for example photographs, according to an easily variable positioning, depending on the user's preference.

### Background

In the cinema and audio-visual field, the post-production of movies comprises an editing phase, of crucial importance, which provides for arranging single frames in the narrative order provided by the script and approved by the director.

From the film, which can have a length of kilometres, the frames have to be cut and isolated, which frames are arranged in sequence, one after the other one, to form the various movie scenes, that is portions which take place in a determined place and period of time. Such procedure is called editing.

The scenes, in turn, are edited in sequence to obtain sequences which, in turn, are arranged still in sequence to complete the movie editing.

During editing, then, the need arises for organizing the whole material (frames, scenes, sequences) so as to be able to manage it with great freedom, by modifying and adjusting progressively its arrangement until a definitive version is obtained.

Up to now, the solutions known to the state of art provide for the use of exhibitors, such as billboards or hoardings, whereon frames extracted from the shot portion and digitalized, rather than photographs/other type of paper documents, are fixed by means of drawing pins, glue or scotch.

Such solutions are commonly adopted even in the fashion sector, wherein the need is recurrent for having to organize paper documents, such as for example photographs, upon creating photo books or presentations.

Unfortunately, when a frame or a photograph are attached to an exhibitor by means of the above-enlisted fastening means, it is difficult to change their positioning in a second moment.

First of all, means such as drawing pins, glue or scotch can damage the frames or the photographs in case of removal and re-application. Moreover, in order to be able to move them on the exhibitor, in each case it is required that they are wholly detached and then re-placed in the new position.

### SUMMARY

The technical problem placed and solved by the present invention then is to provide a device for exposing documents, allowing to obviate the problems mentioned above with reference to the known art.

This is obtained through a support device configured to be able to have available information carrier physical means (such as frames or photographs) in ordered way which can be modified over time, as defined in the independent claim 1.

Secondary features and particular embodiments set forth in the present invention are defined in the depending claims.

Within the present invention, under the expression “information carrier physical means”, or more simply “information carrier means”, any element having a visually usable information, such as a photograph, a frame or a paper document of any nature is meant. For sake of simplicity, reference to photographs will be referred from now on.

The support device according to the present invention comprises an exposing surface thereat the photographs are arranged, according to a positioning which is variable by the user in a simple and quick way.

The device to this purpose comprises tracks and corresponding sliding cursors along the tracks themselves, where the cursors are further configurated for retaining the photographs. Thanks to the sliding of the cursors, it is possible to modify over time the position of the photographs on the exposing surface, for a considerable number of times and above all without having to detach them from the support device.

The invention then proposes to allow the organization and the improved management of material to be arranged according to an order modifiable over time, by solving a problem much felt in the cinema and audio-visual field, when information carriers of physical type are still used.

### BRIEF DESCRIPTION OF FIGURES

The enclosed Figures will be referred to, wherein:

FIG. 1 shows a perspective side view of a first preferred embodiment of a support device according to the present invention;

FIG. 2 shows a perspective side view of a detail of FIG. 1, which comprises a track element coupled to three cursors having a respective photograph;

FIG. 3 shows, in details, a side view of a cursor of FIG. 2;

FIG. 4 shows a side perspective view, in exploded configuration, of a track element, a cursor and a respective photograph, with reference to the preferred embodiment of the support device of FIG. 1;

FIGS. 5 and 6 show respectively, in sequence, the sliding of a photograph on the device of FIG. 1;

FIG. 7 shows a front view of a second preferred embodiment of a support device according to the present invention; and

FIG. 8 shows a front view of a modular support system according to the present invention, comprising a plurality of devices shown in FIG. 7.

### DETAILED DESCRIPTION OF THE INVENTION

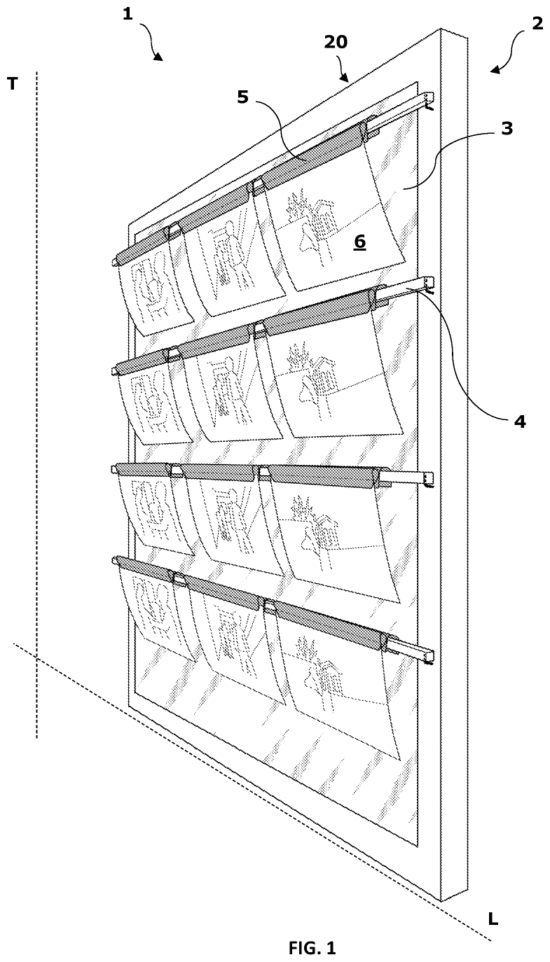

With reference to FIG. 1, a preferred embodiment of a first support device according to the present invention is designated with the reference number 1. The support device 1 is suitable to be used for exposing one or more information physical carriers 6, which can include for example photographs, paper documents, frames. For sake of simplicity, hereinafter in the description one or more photographs 6 will be referred to.

The device 1 comprises a main body 2, carrying an exposing surface 20 thereat the photographs 6 are exposed, in an organized way which can be modified over time. The main body 2 preferably is made of plexiglass, or other at least partially transparent material to allow the passage of the light. Preferably, the exposing surface 20 is a flat surface, developing according to two main longitudinal L and transversal T directions, respectively.

According to preferred embodiments of the invention, the exposing surface 20 comprises lighting means 3. For example, the lighting means 3 can cover the whole exposing surface 20, by making the device 1 particularly suitable for exposing information physical carriers which at least are partially transparent to the light radiation, for example slides.

The main body 2 comprises at least a track element 4, configured to engage with a respective cursor element 5 which in turn is configured to couple with a photograph 6.

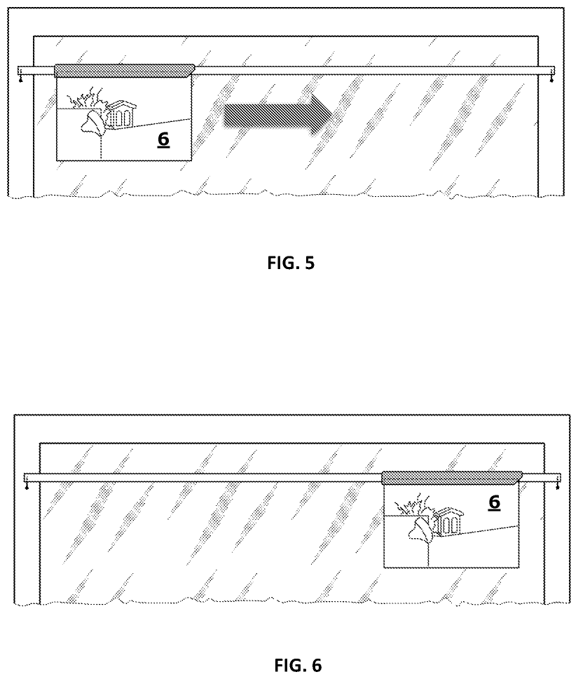

The overall configuration of the support device 1 is so that the arrangement of the photograph 6 coupled to the cursor element 5 can be varied by means of sliding the cursor element 5 with respect to the track element 4, as shown in the exemplified sequences of FIGS. 5 and 6.

The track 4 can have a developing direction according to a straight line B, which preferably can result to be parallel to the longitudinal development direction L of the exposing surface 20, as shown in FIG. 1.

According to additional variants of the invention, the straight line B according thereto the track 4 extends can be parallel to a transversal development direction T of the exposing surface 20.

Moreover, embodiments of the invention are provided wherein there are track elements developing, each one, according to different straight lines, preferably respectively parallel to the longitudinal direction and transversal direction already introduced with reference to the exposing surface. According to such embodiments, the tracks then would extend according to mutually perpendicular directions.

Of course, it is to be meant that within the variants of the invention there are even support devices comprising tracks extending on the exposing surface according to directions oriented according to any angulation with respect to the above-mentioned horizontal and transversal directions, as well as tracks developing along curved paths.

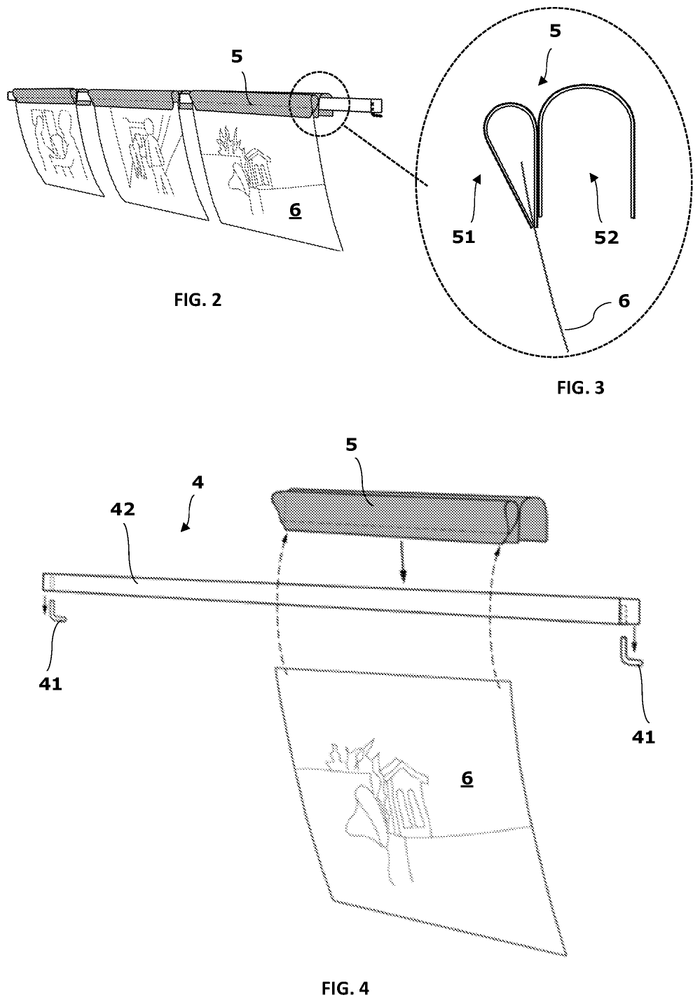

With reference to FIGS. 2 and 4, the track element 4 can have an operating surface 42 protruding with respect to the exposing surface 20.

The operating surface 42 can has a prismatic shape, for example in case of tracks with squared or rectangular section, or with the curved profile, for example in case of tracks the portion thereof protruding with respect to the exposing surface has a half-circular section.

In particular, the track 4 can be removably connected to the exposing surface 20 by means of mechanical coupling means 41, for example implemented by means of pins or hooks associated to the exposing surface as shown in FIG. 4, which insert in corresponding holes obtained on the track 4.

According to such embodiment of the device 1, the cursor element 5 is configured to engage with the track element 4 thanks to its own concave portion 52, shaped in a complementary manner to the operating surface 42 of the track.

In particular, the concave portion 52 of the cursor 5 is configured to house inside thereof at least a portion of the track 4 which protrudes with respect to the exposing surface 20, as shown in FIG. 3.

Additionally, the cursor element 5 is configured to engage with the photograph 6, in particular the cursor element 5 comprises coupling means 51 which preferably carries a clip element, elastically deformable for retaining the photograph.

According to additional embodiments of the invention, the track element instead can be shaped as a recess, re-entering with respect to the exposing surface. Correspondingly, the cursor element is configured to include a portion which at least partially can be inserted in the track, so as to be able to slide therealong.

Alternatively, or in combination to the already described structural shapes, the track 4 and the cursor 5 can include respective magnetic connection means. According to such embodiment, the connection between these last elements can be implemented even exclusively by means of magnetic attraction forces.

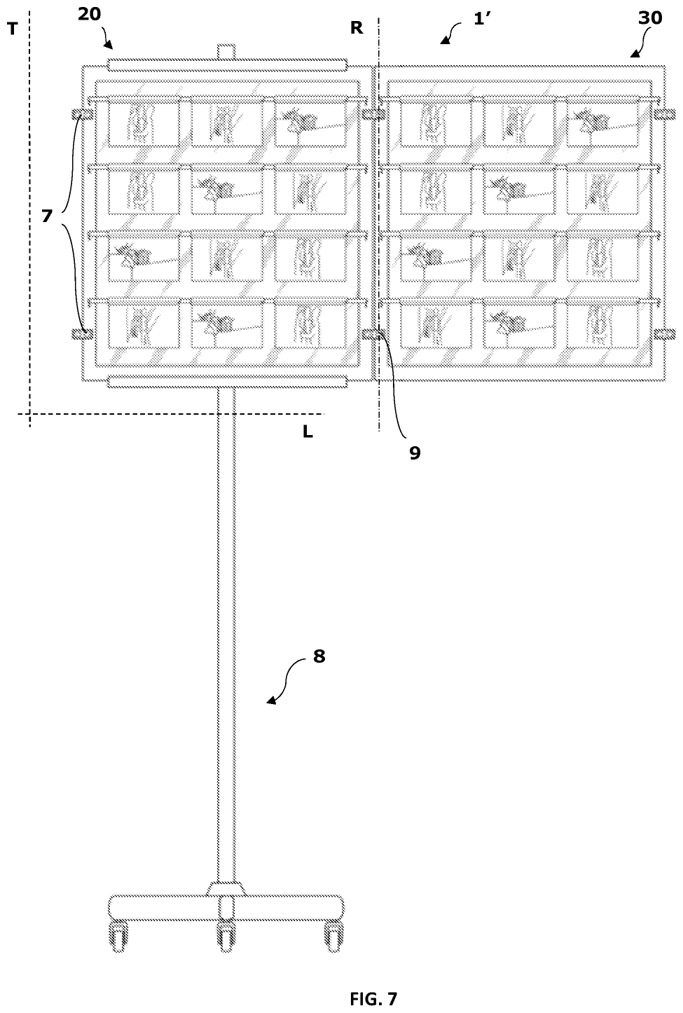

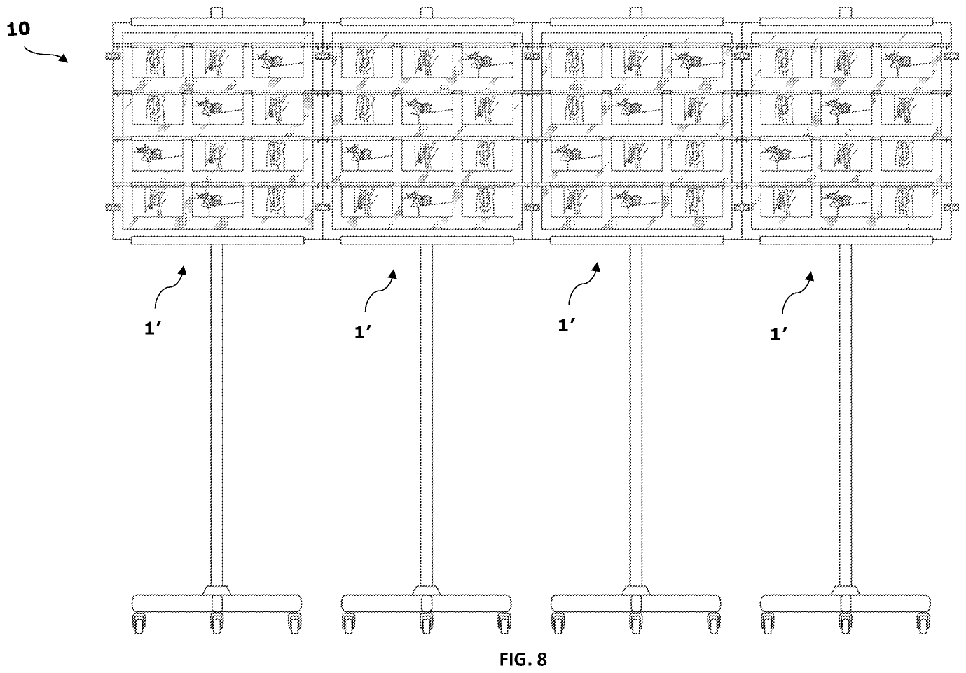

With reference to FIG. 7, an additional embodiment of the support device according to the present invention, designated with reference 1′, is shown. With respect to the already described embodiments, the device 1′ further comprises means 7 for connecting to additional devices 1′, carrying the same connecting means 7. Such means 7 can be configured to implement a mutual mechanical and/or magnetic connection. The presence of the connecting means 7 allows to implement a support system 10 comprising a plurality of support devices 1′ arranged in series, as shown in FIG. 8.

Moreover, the device 1 can include a second exposing surface 30, having all features already described with reference to the exposing surface 20. Such second exposing surface 30 is arranged laterally with respect to the exposing surface 20, thereto it is connected by means of one or more hinges 9 which allow the rotation thereof around an axis R, preferably parallel to the transversal direction T. Thanks to the presence of the hinges 9, the second exposing surface 30 can vary its positioning with respect to the exposing surface 20.

In particular, the second exposing surface 30 can be aligned with respect to the exposing surface 20, as shown in FIG. 7, or it can assume a configuration wherein it abuts on, or better it is superimposed on, the exposing surface 20. According to this last configuration, both exposing surfaces 20, 30 are hidden from view, and the main body of the device 1′ in fact assumes a closed configuration. Such configuration can be used advantageously when one wants to keep hidden the arrangement of the exposed photographs, or when it is necessary to transport the device 1′, to limit the overall dimensions thereof. Preferably, dedicated closing means can be provided to lock the device 1′ in closed configuration, for example comprising hooks or lock elements.

Preferably, the device 1′ comprises tracks according to what already described with reference to other embodiments. In particular, the tracks develop until the peripheral end of the exposing surface, or better of the main body. In this way, when two devices 1′ are coupled in sequence, according to an arrangement in series and with the aligned exposing surfaces, even the tracks result to be aligned to each other, and it is possible to implement the sliding of the information physical carrier from a track to the subsequent one, that is from a support device to the subsequent one.

Still, the device 1′ can include sustaining means 8 to make it a self-supporting structure. The means 8 is configured to implement a support or spacing of the main body with respect to a resting surface, and it comprises for example an even articulated tripod or arm. Preferably, the sustaining means 8 can include rollers, to ease the mobility of the support device 1′. Moreover, for example alternatively to the sustaining means 8, the main body can include hooks or adhesive means to allow to hang it on a wall.

The object of the present invention has been described so far with reference to preferred embodiments thereof, which can be freely combined to each other. It is to be meant that other embodiments belonging to the same inventive core may exist, all belonging to the protective scope of the here below reported claims.

1. A support device for exposing an information physical carrier (6), comprising:
an exposing surface, comprising a track element;
a cursor element, configured to engage with said track element and comprising
means for coupling to the information physical carrier,
the overall configuration of said support device being such that the arrangement of the information physical carrier coupled to said cursor element can be varied by sliding said cursor element with respect to said track element.

2. The support device according to claim 1, wherein said exposing surface is a flat surface, which develops according to two main longitudinal (L) and transversal (T) directions, respectively.

3. The support device according to claim 1, wherein said track element has a development direction according to a straight line (B).

4. The support device according to claim 3, wherein said straight line (B) is parallel to a longitudinal development direction (L) of said exposing surface.

5. The support device according to claim 2, wherein said straight line (B) is parallel to a transversal development direction (T) of said exposing surface.

6. The support device according to claim 1, wherein said track element is shaped like a recess, re-entering with respect to said exposing surface.

7. The support device according to claim 1, wherein said track element has an operating surface protruding with respect to said exposing surface.

8. The support device according to claim 7, wherein said cursor element comprises a concave portion shaped in a complementary manner to said operating surface to house inside thereof at least a portion of said track element protruding with respect to said exposing surface.

9. The support device according to claim 1, wherein said track element and said cursor element comprise respective magnetic connection means.

10. The support device according to claim 1, wherein said coupling means comprises an elastically deformable clip element for retaining the information physical carrier.

11. The support device (T) according to claim 1, comprising a second exposing surface arranged laterally with respect to said exposing surface and connected to the latter by means of one or more hinges, which allow the rotation of said second exposing surface around an axis (R).

12. The support device (T) according to claim 1, comprising means for connecting to additional support devices (T), which carry the same connection means.
